(19) United States
(12) Patent Application Publication
(10) Pub. No.: US 2026/0088512 A1
(43) Pub. Date: Mar. 26, 2026

(54) ANTENNA APPARATUS AND ANTENNA SYSTEM

(71) Applicant: HUAWEI TECHNOLOGIES CO., LTD., Shenzhen (CN)

(72) Inventors: Mingchun Tang, Chongqing (CN); Kejin Chen, Shenzhen (CN); Mei Li, Chongqing (CN); Lin Pu, Chongqing (CN); Jianing Yang, Chongqing (CN); Yi Tan, Chongqing (CN); Hai Xin, Chongqing (CN); Zhi Yang, Chongqing (CN)

(73) Assignee: HUAWEI TECHNOLOGIES CO., LTD., Shenzhen (CN)

(21) Appl. No.: 19/409,669

(22) Filed: Dec. 4, 2025

Related U.S. Application Data
(63) Continuation of application No. PCT/CN2024/092975, filed on May 14, 2024.

(30) Foreign Application Priority Data
Jul. 12, 2023 (CN) 202310862249.2

(51) Int. Cl. H01Q 9/04; H01Q 1/52; H01Q 15/24

(52) U.S. Cl. CPC H01Q 9/0421; H01Q 1/523; H01Q 15/24

(57) ABSTRACT

The disclosure provides an apparatus and system with an antenna array. The antenna array includes a plurality of microstrip antenna elements. Each microstrip antenna element includes a dielectric substrate, a radiation patch, a metal bottom plate, a feeding probe, and a short-circuit pillar. The radiation patch is located on an upper surface of the dielectric substrate, the metal bottom plate is located on a lower surface of the dielectric substrate, the feeding probe penetrates the dielectric substrate and connects one end of the radiation patch to the metal bottom plate, and the short-circuit pillar penetrates the dielectric substrate and connects the other end of the radiation patch to the metal bottom plate. The short-circuit pillar is disposed on the radiation patch, and a first-order mode and a second-order mode are simultaneously excited.

### CROSS-REFERENCE TO RELATED APPLICATIONS

This application is a continuation of International Application No. PCT/CN2024/092975, filed on May 14, 2024, which claims priority to Chinese Patent Application No. 202310862249.2, filed on Jul. 12, 2023. The disclosures of the aforementioned applications are hereby incorporated by reference in their entireties.

### TECHNICAL FIELD

Embodiments of this application relate to the communication field, and in particular, to an antenna apparatus and an antenna system.

### BACKGROUND

As requirements on a mobile communication capacity continuously increase, a communication frequency of a base station gradually develops toward a high frequency band that provides a large bandwidth, and a higher requirement is imposed on full-duplex communication of a high-frequency macro base station. For example, if the base station undertakes both an enhanced mobile broadband (eMBB) transmission task and an uplink centric broadband communication (UCBC) transmission task, it is required that the eMBB and the UCBC have specific isolation while operating at a same frequency, to minimize mutual interference caused between intra-station panels. Therefore, how to improve isolation between a transmit panel and a receive panel to ensure that a high-frequency macro base station full-duplex system operates normally is a key research direction of current base station communication.

In this case, a conventional technology proposes that an isolation wall is loaded in a transmit antenna array and a receive antenna array, and a choke groove is loaded in the isolation wall to implement decoupling between the transmit panel and the receive panel, to improve the isolation between the transmit panel and the receive panel.

However, a loaded decoupling structure (for example, the isolation wall or the choke groove) in the conventional technology has a large size, and is difficult to be used in application scenarios such as a compact array or multiple-input multiple-output (MIMO).

Therefore, an antenna apparatus that can resolve decoupling between the transmit panel and the receive panel and improve the isolation between the transmit panel and the receive panel is urgently needed currently.

### SUMMARY

This application provides an antenna apparatus and an antenna system, to implement coupling suppression on a transmit array and a receive array of the antenna system by suppressing radiation power at a specific angle, so as to improve isolation between a transmit panel and a receive panel.

According to a first aspect, this application provides an antenna apparatus. The antenna apparatus is an antenna array including a plurality of microstrip antenna elements. Each microstrip antenna element includes at least one polarization unit, and each polarization unit includes a dielectric substrate, a radiation patch, a metal bottom plate, a feeding probe, and a short-circuit pillar. The radiation patch is located on an upper surface of the dielectric substrate, the metal bottom plate is located on a lower surface of the dielectric substrate, the feeding probe penetrates the dielectric substrate and connects one end of the radiation patch to the metal bottom plate, and the short-circuit pillar penetrates the dielectric substrate and connects the other end of the radiation patch to the metal bottom plate. When the antenna apparatus operates, each microstrip antenna element is configured to simultaneously excite a first-order mode and a second-order mode through a radiation patch, to generate an asymmetric radiation signal at an operating frequency. The asymmetric radiation signal has a radiation null in a preset area, and the operating frequency is located between a frequency corresponding to the first-order mode and a frequency corresponding to the second-order mode.

In this application, the short-circuit pillar is disposed on the radiation patch, and the first-order mode and the second-order mode are simultaneously excited, so that radiation power of the microstrip antenna element in the preset area can be suppressed, and the radiation null is generated. Therefore, the signal radiated by the microstrip antenna element is asymmetric, and an antenna signal radiated by the antenna array including the plurality of microstrip antenna elements is also asymmetric. Therefore, the antenna system formed by using the antenna array can implement coupling suppression on the transmit array and the receive array of the antenna system, to improve the isolation between the transmit panel and the receive panel.

In a possible implementation, the short-circuit pillar is located near an electric wall generated by the second-order mode on the radiation patch, and a position of the short-circuit pillar does not overlap a position of the electric wall generated by the first-order mode on the radiation patch.

In this implementation, the short-circuit pillar is disposed near the electric wall of the second-order mode, so that a resonant frequency of the first-order mode can be shifted to a high frequency without affecting a resonant frequency of the second-order mode. Therefore, it is helpful to draw the frequency corresponding to the first-order mode and the frequency corresponding to the second-order mode closer, to improve the matching effect of the antenna.

In a possible implementation, a distance between the short-circuit pillar and the feeding probe is greater than ¾ times a length of the radiation patch, and the length of the radiation patch is related to a wavelength corresponding to the operating frequency.

In this implementation, because the electric wall of the second-order mode is generally located at ¾ of the length of the radiation patch, after an amplitude and a phase are adjusted by adjusting the short-circuit pillar, the distance between the short-circuit pillar and the feeding probe is greater than ¾ times the length of the radiation patch. This helps adjust the radiation null to the preset area when it is ensured that the microstrip antenna element can radiate a non-corresponding signal, to help implement coupling suppression on the transmit array and the receive array of the antenna system, so as to improve the isolation between the transmit panel and the receive panel.

In a possible implementation, the radiation patch is presented as a stub-loaded slow-wave transmission structure in a length direction, and the length of the radiation patch is less than or equal to ½ times the wavelength corresponding to the operating frequency.

For example, the length of the radiation patch is approximately 0.4 times the wavelength corresponding to the operating frequency.

In this implementation, when the operating frequency of the microstrip antenna element is between the first-order mode and the second-order mode, a size of the microstrip antenna element is large, and it may be difficult to be suitable for compact array application. Therefore, making the radiation patch into the stub-loaded slow-wave transmission structure helps reduce the size of the radiation patch, and greatly reduce a waveguide wavelength, to miniaturize the size of the microstrip antenna element.

In a possible implementation, the at least one polarization unit is a ±45° dual-polarization unit. A radiation patch of a +45° polarization unit and a radiation patch of a −45° polarization unit are placed in a cross manner, and an insulation medium is disposed between the radiation patch of the +45° polarization unit and the radiation patch of the −45° polarization unit.

In this implementation, each microstrip antenna element is configured as a dual-polarization unit. Compared with implementation of the microstrip antenna element by using a single-polarization unit, the use of the dual-polarization unit not only increases a degree of freedom of the antenna, but also increases a communication capacity and improves an anti-interference capability, thereby helping improve communication performance of the antenna apparatus.

In a possible implementation, a distance between the short-circuit pillar of the +45° polarization unit and a tail end of the radiation patch of the +45° polarization unit is not equal to a distance between the short-circuit pillar of the −45° polarization unit and a tail end of the radiation patch of the −45° polarization unit.

In this implementation, configuring distances from the short-circuit pillar to the tail ends of the radiation patches of the two polarization units to be different helps increase asymmetry of the radiation signal radiated by the microstrip antenna element.

In a possible implementation, the microstrip antenna element further includes a plurality of scattering pillars, and the plurality of scattering pillars are symmetrically distributed around the at least one polarization unit.

For example, the plurality of scattering pillars are located on one side of a connection line between positions of two feeding probes of the ±45° dual-polarization unit, the plurality of scattering pillars are symmetrically distributed based on a perpendicular bisector of the connection line between the positions of the two feeding probes, and two adjacent scattering pillars in the plurality of scattering pillars have a consistent center spacing.

In this implementation, after the scattering pillar is loaded, a surface current near the metal bottom plate on which the microstrip antenna element is located is more concentrated in an area near the loaded scattering pillar. Therefore, disposing the scattering pillar around the at least one polarization unit of the microstrip antenna element helps enhance a suppression effect of the radiation power in the preset area, and enhance asymmetry of the signal radiated by the microstrip antenna element.

In a possible implementation, the antenna apparatus further includes a plurality of electromagnetic band gap structures, and the plurality of electromagnetic band gap structures are evenly distributed around a subarray including at least two microstrip antenna elements.

In this implementation, the electromagnetic band gap structure has characteristics of a frequency band gap and a phase band gap, and can affect propagation of an electromagnetic wave in a specific frequency band. Asymmetric performance (suppression performance) is reduced due to coupling generated between the microstrip antenna elements after the plurality of microstrip antenna elements are arrayed. Therefore, in this implementation, the electromagnetic band gap structure is added to suppress the foregoing coupling, to help enhance isolation between the microstrip antenna elements, and enhance the asymmetric performance (suppression performance), that is, help keep asymmetric performance of the antenna array consistent with asymmetric performance of the microstrip antenna element.

In a possible implementation, the electromagnetic band gap structure includes a metal pillar and a conductor sheet. The conductor sheet is located on a surface of the dielectric substrate. The metal pillar penetrates the dielectric substrate and is connected to a geometric center of the conductor sheet.

In a possible implementation, the subarray includes two microstrip antenna elements. For example, the subarray is a 1×2 subarray or a 2×1 subarray.

According to a second aspect, this application provides an antenna system. The antenna system includes a transmit array and a receive array. The transmit array is configured to transmit an asymmetric radiation signal, and the receive array is configured to receive the asymmetric radiation signal. The transmit array may be implemented by using the antenna apparatus described in any implementation of the first aspect, and the receive array may be implemented by using the antenna apparatus described in any implementation of the first aspect.

### BRIEF DESCRIPTION OF DRAWINGS

FIG. 1 is a diagram of an embodiment of a microstrip antenna element according to this application;

FIG. 2A is an example diagram of a design principle of a microstrip antenna element according to this application;

FIG. 2B is an example diagram of comparison between directivity patterns of a microstrip antenna element corresponding to steps in FIG. 2A;

FIG. 3A is a top view of a miniaturized microstrip antenna element according to this application;

FIG. 3B is a three-dimensional diagram of a miniaturized microstrip antenna element according to this application;

FIG. 4A is a three-dimensional diagram of a miniaturized dual-polarization microstrip antenna element according to this application;

FIG. 4B is a top view and a sectional view of a miniaturized dual-polarization microstrip antenna element according to this application;

FIG. 5A is a three-dimensional diagram of a microstrip antenna element configured with a scattering pillar according to this application;

FIG. 5B is a top view of a microstrip antenna element configured with a scattering pillar according to this application;

FIG. 6 is a diagram of surface current distribution on a metal bottom plate of a dual-polarization antenna element with no scattering pillar loaded and with a scattering pillar loaded according to this application;

FIG. 7 is an example diagram of comparison between directivity patterns of a dual-polarization antenna element and a conventional dual-polarization antenna element according to this application;

FIG. 8A is a three-dimensional diagram of an electromagnetic band gap structure according to this application;

FIG. 8B is a top view of an electromagnetic band gap structure according to this application;

FIG. 9 is an example diagram of a dispersion curve obtained through simulation of an electromagnetic band gap structure under a periodic boundary condition according to this application;

FIG. 10 is an example diagram of an antenna array including a plurality of microstrip antenna elements and a plurality of electromagnetic band gap structures according to this application;

FIG. 11 is an example diagram of an impedance bandwidth of an antenna array according to this application;

FIG. 12 is an example diagram of comparison between radiation patterns of an antenna array provided in this application and a conventional antenna array at 25.5 GHz;

FIG. 13 is an example diagram of comparison between port isolation of an antenna array provided in this application and a conventional antenna array; and

FIG. 14 is an example diagram of an antenna system including an antenna array according to this application.

### DESCRIPTION OF EMBODIMENTS

The following clearly and completely describes the technical solutions in embodiments of this application with reference to the accompanying drawings in embodiments of this application. It is clear that the described embodiments are merely some but not all of embodiments of this application.

In the specification, claims, and accompanying drawings of this application, the terms “first”, “second”, “third”, “fourth”, and so on (if existent) are intended to distinguish between similar objects but do not necessarily indicate a specific order or sequence. It should be understood that the terminology termed in such a way are interchangeable in proper circumstances so that embodiments of the present disclosure described herein can be implemented in other orders than the order illustrated or described herein. In addition, the terms “include” and “have” and any other variants are intended to cover the non-exclusive inclusion. For example, a process, method, system, product, or device that includes a list of steps or units is not necessarily limited to those expressly listed steps or units, but may include other steps or units not expressly listed or inherent to such a process, method, product, or device.

It should be understood that the term “and/or” in this specification describes only an association relationship between associated objects and represents that three relationships may exist. For example, A and/or B may represent the following three cases: Only A exists, both A and B exist, and only B exists. In addition, the character “/” in this specification generally indicates an “or” relationship between the associated objects.

The following first briefly describes terms in this application.

Asymmetry: Asymmetry means a radiation pattern of an antenna is asymmetric. Compared with a symmetric radiation pattern of a conventional antenna, directivity patterns on two sides are not completely consistent because an antenna element proposed in this application can effectively suppress radiation power in a specific area on a lateral side, but does not suppress radiation power in a same area on a different side, which is referred to as asymmetry.

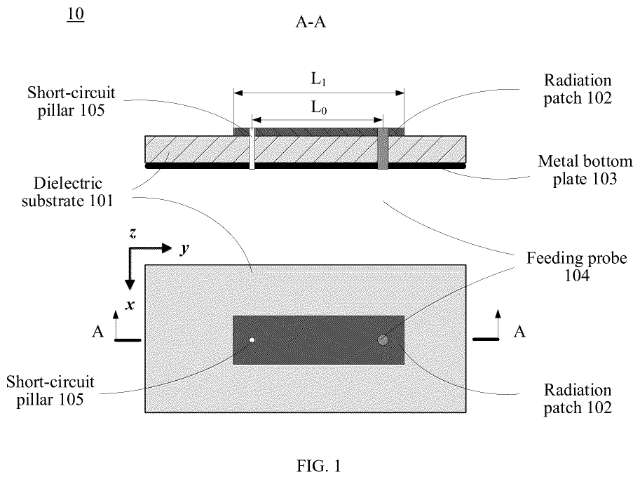

First-order mode: The first-order mode is a field strength mode in which only one half-wave is distributed in an electric field in a length direction (namely, a direction of a longer side) of a radiation patch of a microstrip antenna element. For example, as shown in FIG. 1, if the direction of the longer side of the radiation patch is defined as a y direction, and a direction of a shorter side of the radiation patch is defined as an x direction, the first-order mode is a TM01 mode. For another example, if the direction of the longer side of the radiation patch is defined as an x direction, and a direction of a shorter side of the radiation patch is defined as a y direction, the first-order mode is a TM10 mode. This application is described by using an example shown in FIG. 1.

Second-order mode: The second-order mode is a field strength mode in which two half-waves are distributed in the electric field in the length direction (namely, the direction of the longer side) of the radiation patch of a microstrip antenna element. For example, as shown in FIG. 1, if the direction of the longer side of the radiation patch is defined as a y direction, and a direction of a shorter side of the radiation patch is defined as an x direction, the second-order mode is a TM02 mode. For another example, if the direction of the longer side of the radiation patch is defined as an x direction, and a direction of a shorter side of the radiation patch is defined as a y direction, the second-order mode is a TM20 mode. This application is described by using an example shown in FIG. 1.

Electric wall: The electric wall is a curved surface that meets an ideal boundary condition of a conductor, that is, both E and H are 0 in the conductor. A power line is perpendicular to a surface of the conductor. A magnetic line is parallel to the surface of the conductor. Generally, a surface that intersects with the power line vertically is referred to as an electric wall.

Spatial angle filter antenna: Compared with a symmetric radiation pattern of a conventional antenna, a proposed antenna element can effectively suppress radiation power in a specific angle area in a lateral direction, so that there is a radiation null in the direction. In this case, the antenna element is a spatial angle filter antenna.

An antenna apparatus provided in this application includes an antenna array including a plurality of microstrip antenna elements. Because a directivity pattern of a signal radiated by each microstrip antenna element is asymmetric, a signal integrally radiated by the antenna apparatus also has good asymmetry. This helps implement coupling suppression on a transmit array and a receive array of an antenna system, to improve isolation between a transmit panel and a receive panel.

The following describes a structure of each microstrip antenna element 10 with reference to FIG. 1.

FIG. 1 is a diagram of an embodiment of the microstrip antenna element 10 according to this application. Each microstrip antenna element 10 includes a dielectric substrate 101, a radiation patch 102, a metal bottom plate 103, a feeding probe 104, and a short-circuit pillar 105. It should be noted that, when a plurality of microstrip antenna elements 10 form an antenna array, the plurality of microstrip antenna elements 10 share a same dielectric substrate 101, and the plurality of microstrip antenna elements 10 share a same metal bottom plate 103.

The dielectric substrate 101 is formed by an insulation medium, and the radiation patch 102, the metal bottom plate 103, the feeding probe 104, and the short-circuit pillar 105 are respectively made of conductive materials such as metal. The dielectric substrate 101 is configured to carry the radiation patch 102 and the metal bottom plate 103. The radiation patch 102 is located on an upper surface of the dielectric substrate 101 as a radiator, and the metal bottom plate 103 is located on a lower surface of the dielectric substrate 101 as a grounding plate. As a feeding apparatus, the feeding probe 104 connects the radiation patch 102 to the metal bottom plate 103. As a short-circuit apparatus, the short-circuit pillar 105 implements short-circuit between the radiation patch 102 and the metal bottom plate 103. The feeding probe 104 and the short-circuit pillar 105 are respectively located at two ends of the radiation patch 102. For example, the feeding probe 104 penetrates the dielectric substrate 101 and connects one end of the radiation patch 102 to the metal bottom plate 103, and the short-circuit pillar 105 penetrates the dielectric substrate 101 and connects the other end of the radiation patch 102 to the metal bottom plate 103.

When the microstrip antenna element 10 operates, the microstrip antenna element 10 simultaneously excites a first-order mode and a second-order mode through the radiation patch 102, to generate an asymmetric radiation signal at an operating frequency. The asymmetric radiation signal has a radiation null in a preset area, and the operating frequency is located between a frequency corresponding to the first-order mode and a frequency corresponding to the second-order mode.

The first-order mode is a field strength mode in which only one half-wave is distributed in an electric field in a length direction (namely, a direction of a longer side) of the radiation patch 102 of the microstrip antenna element 10. The second-order mode is a field strength mode in which two half-waves are distributed in the electric field in the length direction (namely, the direction of the longer side) of the radiation patch 102 of the microstrip antenna element 10. When the microstrip antenna element 10 simultaneously excites the first-order mode and the second-order mode through the radiation patch 102 on which the short-circuit pillar 105 is disposed, the asymmetric radiation signal is radiated by generating an uneven current on the radiation patch 102. The asymmetric radiation signal has the radiation null in the preset area, that is, radiation power of a directivity pattern of the antenna in the preset area is low, so that radiation power of an entire directivity pattern presents an asymmetric distribution rule. Optionally, the short-circuit pillar 105 is located near an electric wall generated by the second-order mode on the radiation patch, and a position of the short-circuit pillar 105 does not overlap the electric wall generated by the first-order mode on the radiation patch.

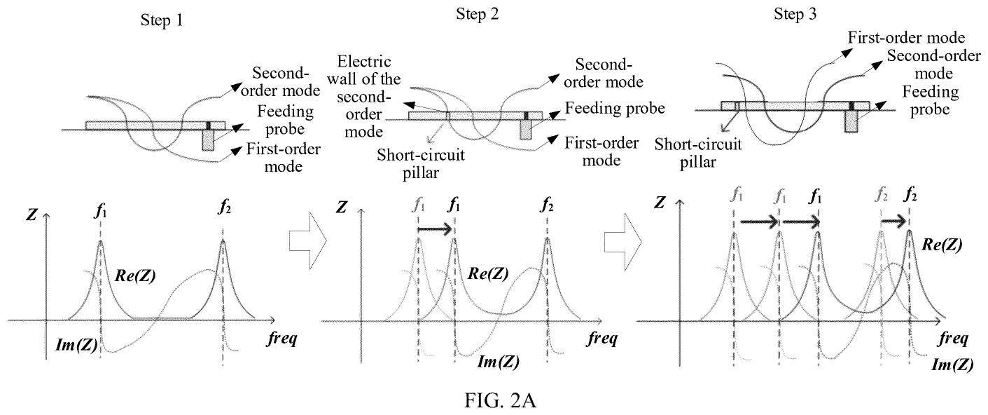

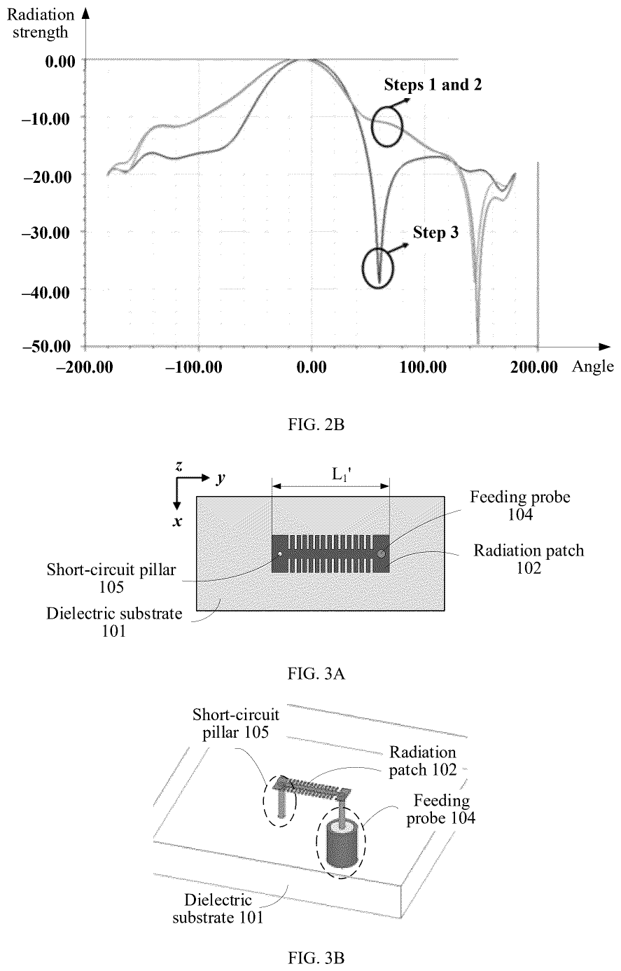

For ease of understanding, the following describes, with reference to FIG. 2A, a principle of radiating an asymmetric signal by the microstrip antenna element.

Step 1 in FIG. 2A is an example diagram of a microstrip antenna element that is not configured with a short-circuit apparatus and that uses a feeding probe. When the microstrip antenna element simultaneously excites the first-order mode (for example, a TM01 mode) and the second-order mode (for example, a TM02 mode), although the current on the patch may be unevenly distributed, because a frequency corresponding to the first-order mode and a frequency corresponding to the second-order mode differ by a factor of two, that is, a frequency f2 corresponding to the second-order mode is equal to twice the frequency corresponding to the second-order mode, it is difficult to implement matching between the two modes in a same frequency band. To successfully excite the two modes simultaneously, a short-circuit pillar is loaded at the edge of the microstrip antenna element to draw the two modes closer, to improve a matching effect of the antenna. As shown in Step 2 in FIG. 2A, a short-circuit pillar is disposed near the electric wall of the second-order mode, so that the frequencies corresponding to the two modes are drawn closer. For example, after the short-circuit pillar is configured for the radiation patch, a center frequency of the first-order mode can move toward the second-order mode when the frequency of the second-order mode remains unchanged, so that a frequency difference between the first-order mode and the second-order mode is reduced. For example, a difference between f2 and f1 in Step 2 in FIG. 2A is less than a difference between f2 and f1 in FIG. 2A. Then, as shown in Step 3 in FIG. 2A, the short-circuit pillar is moved in a direction away from the feeding probe, so that a current amplitude ratio and a phase difference between the two modes can be adjusted while the frequencies corresponding to the two modes are drawn closer. In this way, radiation energy of the signal radiated by the microstrip antenna element is suppressed in the preset area, and the radiation null is generated. In the example shown in FIG. 2B, the radiation null is generated on the microstrip antenna element near 60° by adjusting a position of the short-circuit pillar. In this example, the short-circuit pillar is disposed near the electric wall of the second-order mode, so that a resonant frequency of the first-order mode can be shifted to a high frequency without affecting a resonant frequency of the second-order mode. Therefore, it is helpful to draw the frequency corresponding to the first-order mode and the frequency corresponding to the second-order mode closer, to improve the matching effect of the antenna.

In this implementation, the short-circuit pillar 105 is disposed on the radiation patch 102, and the first-order mode and the second-order mode are simultaneously excited, so that radiation power of the microstrip antenna element 10 in the preset area can be suppressed, and the radiation null is generated. Therefore, the signal radiated by the microstrip antenna element 10 is asymmetric, and an antenna signal radiated by the antenna array including the plurality of microstrip antenna elements 10 is also asymmetric. Therefore, the antenna system formed by using the antenna array can implement coupling suppression on the transmit array and the receive array of the antenna system, to improve the isolation between the transmit panel and the receive panel.

Optionally, a distance (namely, L₀ in FIG. 1) between the short-circuit pillar 105 and the feeding probe 104 is greater than ¾ times a length (namely, L₁ in FIG. 1) of the radiation patch 102, and the length of the radiation patch 102 is related to a wavelength corresponding to the operating frequency. For example, the length of the radiation patch 102 is 0.5 times the wavelength corresponding to the operating frequency. Because the electric wall of the second-order mode is generally located at ¾ of the length of the radiation patch 102, after an amplitude and a phase are adjusted by adjusting the short-circuit pillar 105, the distance between the short-circuit pillar 105 and the feeding probe 104 is greater than ¾ times the length of the radiation patch 102. This helps adjust the radiation null to the preset area when it is ensured that the microstrip antenna element can radiate a non-corresponding signal, to help implement coupling suppression on the transmit array and the receive array of the antenna system, so as to improve the isolation between the transmit panel and the receive panel.

Further, in a possible implementation, as shown in FIG. 3A and FIG. 3B, the radiation patch 102 is presented as a stub-loaded slow-wave transmission structure in the length direction. The slow-wave transmission structure loaded on the stub is presented as a symmetrical sawtooth shape in the length direction of the radiation patch 102. A size of the radiation patch 102 in the length direction can be reduced by configuring the radiation patch 102 as the stub-loaded slow-wave transmission structure. To be specific, when a same radiation signal is obtained, the length (for example, L₁′ in FIG. 3A) of the radiation patch configured as the stub-loaded slow-wave transmission structure is less than a length (for example, L₁ in FIG. 1) of a common rectangular radiation patch. Optionally, the length of the radiation patch 102 is less than or equal to ½ times the wavelength corresponding to the operating frequency. For example, the length of the radiation patch 102 is approximately 0.4 times the wavelength corresponding to the operating frequency. For example, the width of the radiation patch 102 is approximately equal to 0.08 times the wavelength corresponding to the operating frequency.

In this implementation, when the operating frequency of the microstrip antenna element 10 is between the frequency corresponding to the first-order mode and the frequency corresponding to the second-order mode, a size of the microstrip antenna element is large (that is, the size of the radiation patch in the length direction is large, for example, the size of the radiation patch in the length direction is greater than or close to ½ times of the wavelength corresponding to the operating frequency), and therefore, it may be difficult to be suitable for application of a compact array. Therefore, making the radiation patch into the stub-loaded slow-wave transmission structure helps reduce the size of the radiation patch, and greatly reduce a waveguide wavelength, to miniaturize the size of the microstrip antenna element.

Further, each microstrip antenna element 10 includes at least one polarization unit.

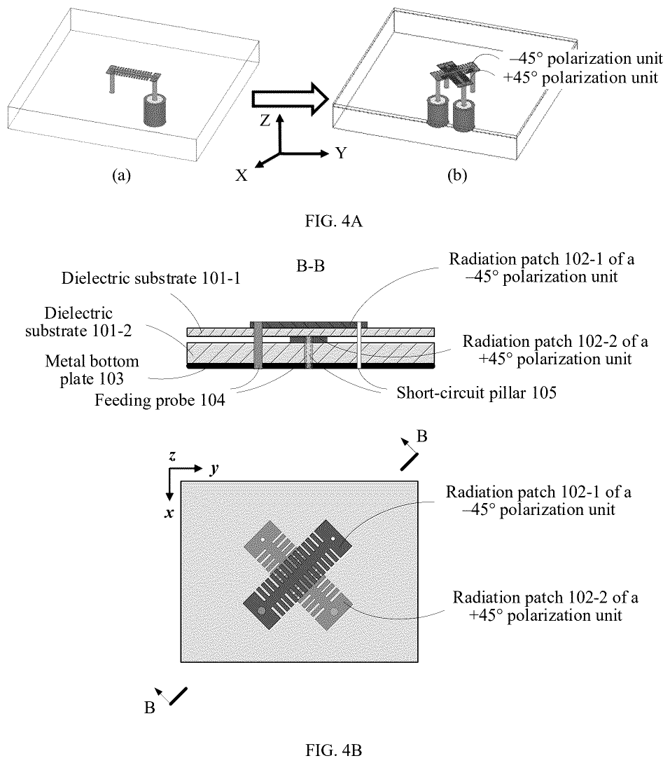

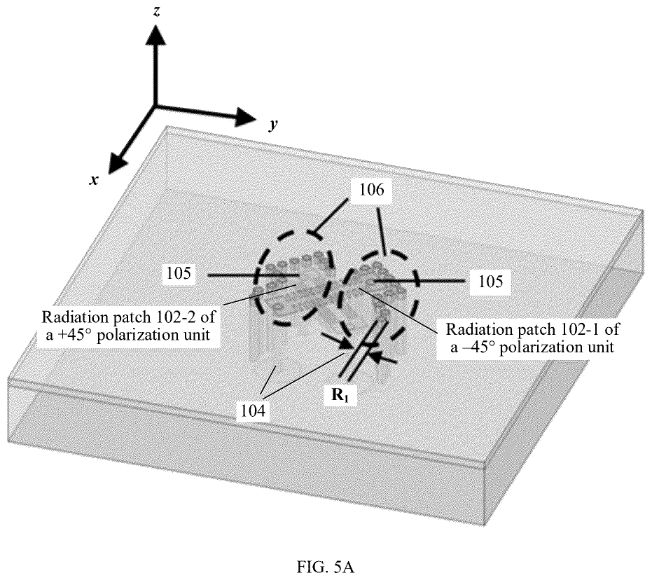

In a possible implementation, in the example (a) on the left side of FIG. 4A, each microstrip antenna element 10 includes one polarization unit, and each polarization unit includes one radiation patch 102, one feeding probe 104, and one short-circuit pillar 105. When a plurality of single-polarization microstrip antenna elements 10 form an antenna array, the plurality of microstrip antenna elements 10 share a same dielectric substrate 101, and the plurality of microstrip antenna elements 10 share a same metal bottom plate 103.

In another possible implementation, as shown in example (b) on the left side of FIG. 4A, each microstrip antenna element 10 includes two polarization units with different polarization directions, that is, each microstrip antenna element 10 is a dual-polarization unit. Because each polarization unit includes one radiation patch 102, one feeding probe 104, and one short-circuit pillar 105, each microstrip antenna element 10 includes two radiation patches 102, two feeding probes 104, and two short-circuit pillars 105, and the two polarization units share a same dielectric substrate 101 and a same metal bottom plate 103.

In the example (b) shown in FIG. 4A, the microstrip antenna element 10 is a ±45° dual-polarization unit. A radiation patch of a +45° polarization unit and a radiation patch of a −45° polarization unit are placed in a cross manner, and an insulation medium is disposed between the radiation patch of the +45° polarization unit and the radiation patch of the −45° polarization unit.

For example, as shown in FIG. 4B, the microstrip antenna element includes two layers of dielectric substrates (namely, a dielectric substrate 101-1 and a dielectric substrate 101-2). The upper-layer dielectric substrate 101-1 is mainly configured to print the radiation patch 102-1 of the −45° polarization unit, and the lower-layer dielectric substrate 101-2 is mainly configured to print the radiation patch 102-2 of the +45° polarization unit and the metal bottom plate 103. For example, the radiation patch 102-1 of the −45° polarization unit is located on an upper surface of the upper-layer dielectric substrate 101-1, the radiation patch 102-2 of the +45° polarization unit is located on an upper surface of the lower-layer dielectric substrate 101-2, and the metal bottom plate 103 is located on a lower surface of the lower-layer dielectric substrate 101-2.

Optionally, a distance between the short-circuit pillar 105 of the +45° polarization unit and a tail end of the radiation patch 102-2 of the +45° polarization unit is not equal to a distance between the short-circuit pillar 105 of the −45° polarization unit and a tail end of the radiation patch 102-1 of the −45° polarization unit.

In this implementation, each microstrip antenna element 10 is configured as a dual-polarization unit. Compared with implementation of the microstrip antenna element 10 by using a single-polarization unit, the use of the dual-polarization unit not only increases a degree of freedom of the antenna, but also increases a communication capacity and improves an anti-interference capability, thereby helping improve communication performance of the antenna system. In addition, configuring distances from the short-circuit pillar 105 to the tail ends of the radiation patches of the two polarization units to be different helps increase asymmetry of the radiation signal radiated by the microstrip antenna element 10.

Further, in a possible implementation, the microstrip antenna element 10 further includes a plurality of scattering pillars, and the plurality of scattering pillars are symmetrically distributed around the at least one polarization unit.

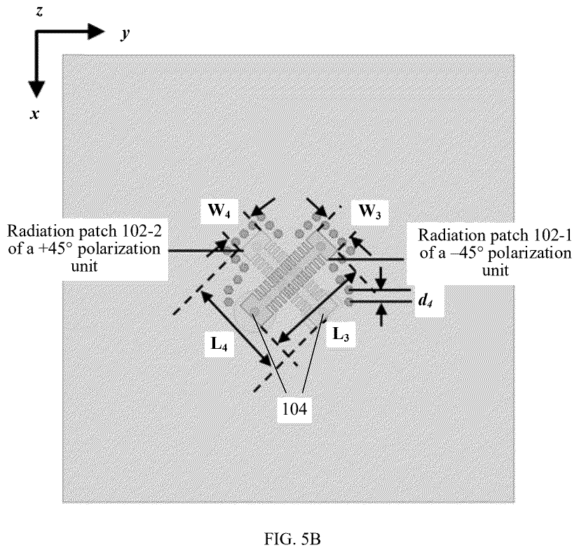

As shown in FIG. 5A and FIG. 5B, an example in which the microstrip antenna element 10 includes a ±45° dual-polarization unit is used for description. The plurality of scattering pillars 106 are symmetrically distributed around the ±45° dual-polarization unit. Optionally, the plurality of scattering pillars 106 are located on one side of a connection line between positions of two feeding probes 104 of the ±45° dual-polarization unit, and the plurality of scattering pillars 106 are symmetrically distributed based on a perpendicular bisector of the connection line between the positions of the two feeding probes 104.

Optionally, two adjacent scattering pillars 106 in the plurality of scattering pillars 106 have a consistent center spacing, that is, the plurality of scattering pillars 106 are evenly distributed around the ±45° dual-polarization unit. In the example shown in FIGS. 5B, 24 scattering pillars 106 are disposed around the ±45° dual-polarization unit. It should be understood that, in actual application, a quantity of scattering pillars 106 disposed around the ±45° dual-polarization unit may be adjusted, and correspondingly, a center spacing between two adjacent scattering pillars 106 may also be adjusted. This is not limited herein.

In an example, as shown in FIG. 5A and FIG. 5B, a radius R₁ of the scattering pillar 106 is 0.1 mm to 0.2 mm, and a center spacing d₄ between adjacent scattering pillars 106 is 0.4 mm to 0.8 mm. A radius R₂ of the short-circuit pillar 105 is 0.05 mm to 0.2 mm. A length L₃ of the radiation patch 102-1 of the −45° polarization unit is 3.3 mm to 3.9 mm, and a width W₃ is 0.84 mm to 1.24 mm. A length L₄ of the radiation patch 102-2 of the +45° polarization unit is 3 mm to 3.6 mm, and a width W₄ is 0.84 mm to 1.24 mm.

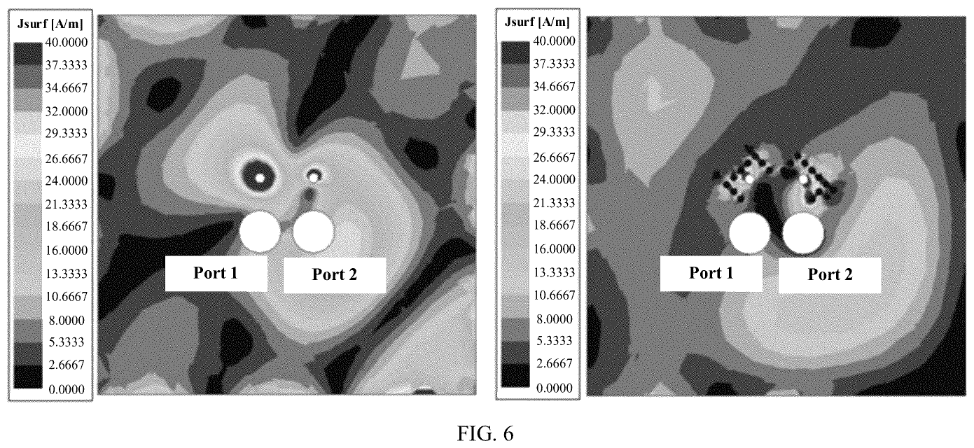

FIG. 6 is a diagram of surface current distribution on a metal bottom plate of a dual-polarization antenna element with no scattering pillar loaded and with a scattering pillar loaded according to this application. As shown in FIG. 6, after the scattering pillar 106 is loaded, a surface current near the metal bottom plate 103 on which the microstrip antenna element 10 is located is more concentrated in an area near the loaded scattering pillar 106. Therefore, disposing the scattering pillar 106 around the at least one polarization unit of the microstrip antenna element 10 helps enhance a suppression effect of the radiation power in the preset area, and enhance asymmetry of the signal radiated by the microstrip antenna element 10.

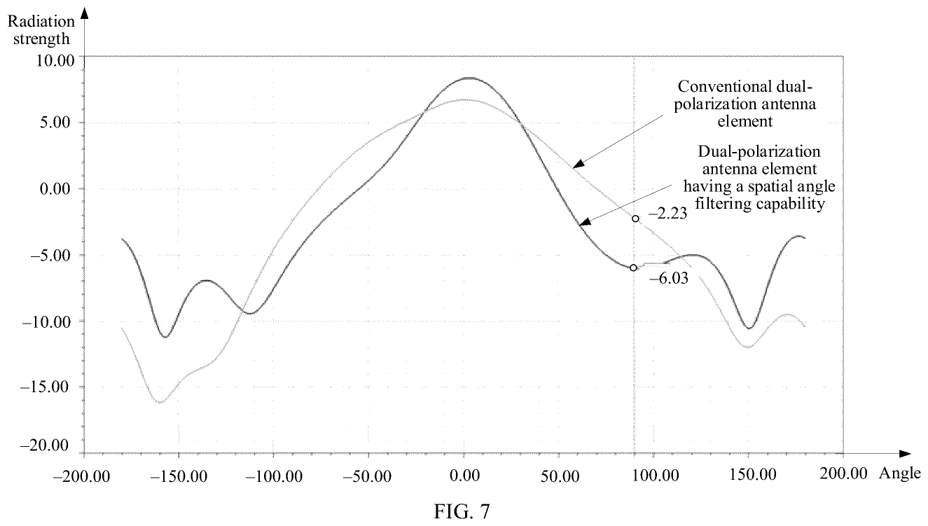

In addition, FIG. 7 shows comparison between directivity patterns of a dual-polarization antenna element, provided in this application, having a spatial angle filtering capability and a conventional dual-polarization antenna element in a 25 GHz antenna element. Compared with that of the conventional antenna element, a side lobe level of the dual-polarization antenna element proposed in this application is reduced by 3.8 dB, that is, a side lobe level at a specific angle can be effectively suppressed, to implement good asymmetry.

Further, in a possible implementation, the antenna apparatus provided in this application further includes a plurality of electromagnetic band gap structures (EBG) 20. The electromagnetic band gap structure 20 is an artificial periodic structure, has characteristics of a frequency band gap and a phase band gap, and can affect propagation of an electromagnetic wave in a specific frequency band.

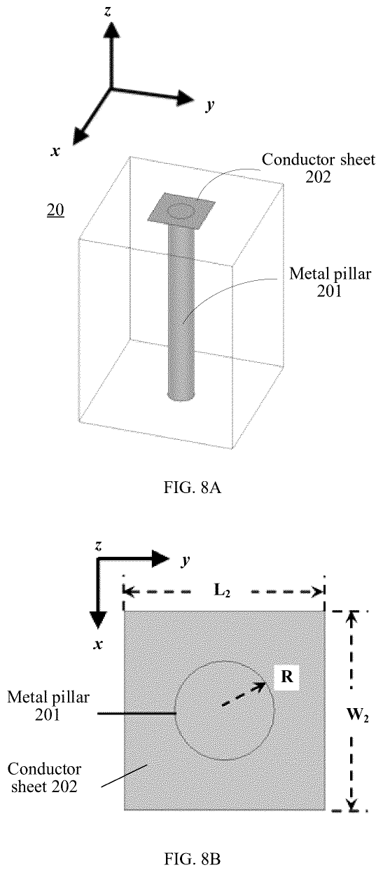

As shown in FIG. 8A, the electromagnetic band gap structure 20 includes a metal pillar 201 and a conductor sheet 202. The conductor sheet 202 is located on a surface of the dielectric substrate 101. The metal pillar 201 penetrates the dielectric substrate 101 and is connected to a geometric center of the conductor sheet 202. For example, as shown in FIG. 8A, the conductor sheet 202 in the electromagnetic band gap structure 20 may be a square metal patch, and the metal pillar 201 coincides with a geometric center of the square patch. Asymmetric performance (suppression performance) is reduced due to coupling generated between the microstrip antenna elements 10 after the plurality of microstrip antenna elements 10 are arrayed. Therefore, the electromagnetic band gap structure 20 is added to suppress the foregoing coupling, to enhance isolation between the microstrip antenna elements 10, and enhance the asymmetric performance (suppression performance), that is, help keep asymmetric performance of the antenna array consistent with asymmetric performance of the microstrip antenna element.

In an example, as shown in FIG. 8B, a radius R of the metal pillar 201 is 0.05 mm to 0.15 mm. A length L₂ of the square patch is 0.3 mm to 0.7 mm, and a width W₂ is 0.3 mm to 0.7 mm. The length L₂ of the square patch is related to the operating frequency of the antenna element. For example, the operating frequency of the antenna element is 25.8 G, and the length L₂ of the square patch is approximately equal to 0.04 times the wavelength of the operating frequency.

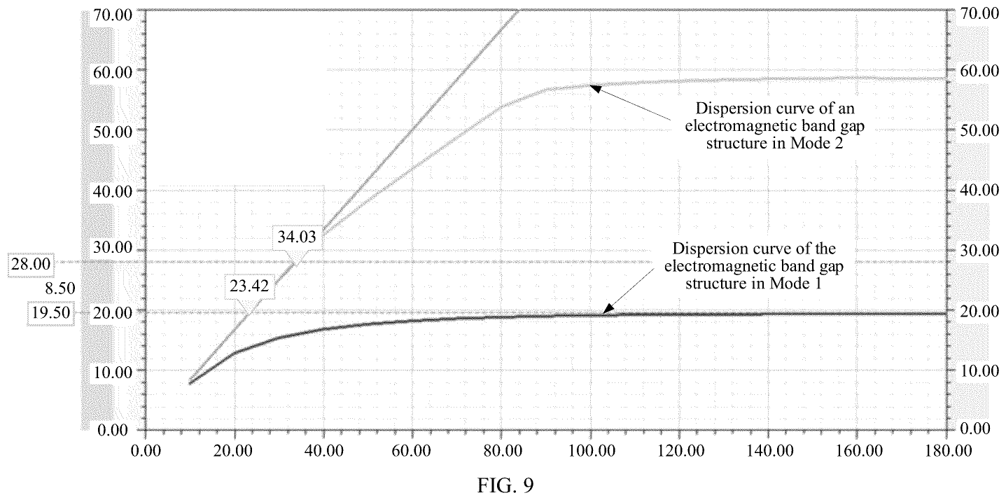

FIG. 9 shows a dispersion curve obtained through simulation of the electromagnetic band gap structure 20 provided in this application under a periodic boundary condition. It can be learned from a simulation result shown in FIG. 9 that, in a specific size (for example, a size shown in FIG. 8B), a surface wave at 19.5 GHz or even a higher frequency can be effectively suppressed, so that the radiation null can be obtained by suppressing the radiation power in the preset area.

Further, the plurality of electromagnetic band gap structures 20 are evenly distributed around a subarray including at least two microstrip antenna elements 10. Optionally, one subarray includes two microstrip antenna elements 10. For example, the subarray including the at least two microstrip antenna elements 10 is a 1×2 subarray or a 2×1 subarray. Optionally, one subarray includes four microstrip antenna elements 10. For example, the subarray including the at least two microstrip antenna elements 10 is a 2×2 subarray. This is not limited herein. Compared with a conventional technology in which a plurality of electromagnetic band gap structures are distributed on only one microstrip antenna element, in this application, a plurality of electric field band gap structures are evenly distributed around at least two microstrip antenna elements, so that radiation directions of the at least two microstrip antenna elements are consistent, thereby ensuring asymmetry of a directivity pattern of an entire antenna apparatus.

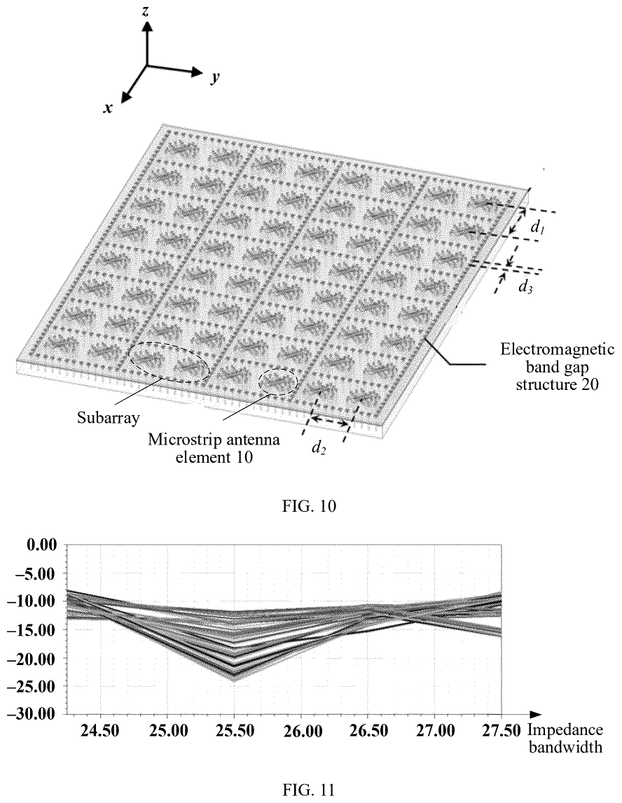

For example, the subarray including the at least two microstrip antenna elements 10 is a 1×2 subarray. As shown in FIG. 10, every two microstrip antenna elements 10 form one subarray (namely, a 1×2 subarray), and a plurality of electromagnetic band gap structures 20 are evenly distributed around the 1×2 subarray. In addition, a plurality of subarray groups are regularly arranged as an antenna array, and a plurality of electromagnetic band gap structures 20 are evenly distributed around each 1×2 subarray in the antenna array. For example, a row spacing between adjacent microstrip antenna elements 10 in the antenna array is 0.6 times the wavelength corresponding to the operating frequency, and a column spacing between adjacent microstrip antenna elements 10 is 0.5 times the wavelength corresponding to the operating frequency.

In an example, as shown in FIG. 10, the antenna array includes 64 dual-polarization antenna elements, a scale of the antenna array is 8×8, a row spacing d₁ between adjacent microstrip antenna elements 10 is 7 mm to 8 mm, and a column spacing d₂ between adjacent microstrip antenna elements 10 is 5.75 mm to 6.75 mm. An adjacent spacing d₃ between electromagnetic band gap structures 20 is 0.87 mm to 1.27 mm.

FIG. 11 shows an impedance bandwidth of an antenna array, provided in this application, having a spatial angle filtering capability. It can be learned from a simulation result shown in FIG. 11 that an impedance bandwidth range of the antenna array is 24.7 GHz to 27.1 GHz.

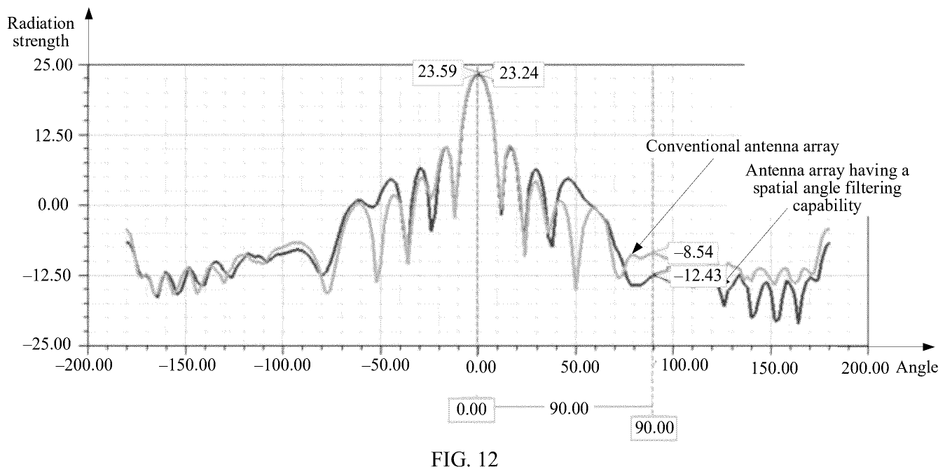

FIG. 12 shows comparison between radiation patterns of an antenna array, provided in this application, having a spatial angle filtering capability and a conventional antenna array at 25.5 GHz. It can be learned from a simulation result shown in FIG. 12 that, compared with that in a directivity pattern of the conventional antenna array at 25 GHz, a side lobe level of the antenna array, provided in this application, having the spatial angle filtering capability can be reduced by 3.89 dB.

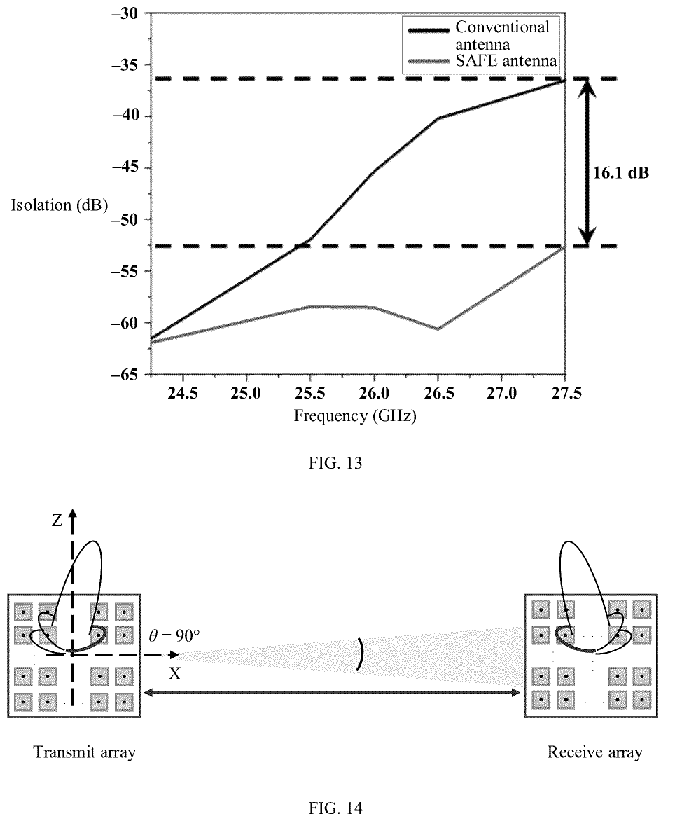

FIG. 13 shows comparison between port isolation of an antenna array, provided in this application, having a spatial angle filtering capability and a conventional antenna array. It can be learned from a simulation result shown in FIG. 13 that, compared with the conventional antenna array, in an entire frequency band in which an antenna operates, the antenna array, provided in this application, having the spatial angle filtering capability has a more significant isolation increase effect compared with the conventional antenna array in ±15° spatial domain scanning, where port isolation can be increased by 16.1 dB.

FIG. 14 is an example diagram of an antenna system including an antenna array according to this application. The antenna system includes a transmit array and a receive array. Specific implementations of the transmit array and the receive array are the antenna apparatus shown in FIG. 10. A signal radiated by the transmit array has a radiation null in a preset area, and a signal radiated by the receive array has a radiation null in the preset area. A side that is of the transmit array and on which the radiation null exists and a side that is of the receive array and on which the radiation null exists are disposed opposite to each other, that is, the side that is of the transmit array and on which side lobe suppression exists and the side that is of the receive array and on which side lobe suppression exists are disposed opposite to each other, so that the transmit array and the receive array can be well isolated, to improve communication performance of the antenna.

In this implementation, not only the microstrip antenna element 10 suppresses the radiation power in the preset area to generate the radiation null, but also the electromagnetic band gap structure 20 constructs a 1×2 subarray form, so that directivity patterns of the microstrip antenna elements 10 in the array have good consistency. Therefore, the antenna array including the microstrip antenna element 10 and the electromagnetic band gap structure 20 can not only implement coupling suppression on the transmit array and the receive array of the antenna system, to improve isolation between a transmit panel and a receive panel, and can also ensure good isolation in a case of a quasi-far field spacing and independent scanning of the transmit antenna array and the receive antenna array.

The foregoing embodiments are merely intended for describing the technical solutions of this application, but not for limiting this application. Although this application is described in detail with reference to the foregoing embodiments, persons of ordinary skill in the art should understand that they may still make modifications to the technical solutions recorded in the foregoing embodiments or make equivalent replacements to some technical features thereof. Such modifications or replacements do not make the essence of the corresponding technical solutions depart from the spirit and the scope of the technical solutions of embodiments of this application.

1. An apparatus, comprising:
an antenna array comprising a plurality of microstrip antenna elements that each comprise at least one polarization unit, wherein each polarization unit comprises a dielectric substrate, a radiation patch, a metal bottom plate, a feeding probe, and a short-circuit pillar, the radiation patch is located on an upper surface of the dielectric substrate, the metal bottom plate is located on a lower surface of the dielectric substrate, the feeding probe penetrates the dielectric substrate and connects one end of the radiation patch to the metal bottom plate, and the short-circuit pillar penetrates the dielectric substrate and connects the other end of the radiation patch to the metal bottom plate; and
each microstrip antenna element is configured to simultaneously excite a first-order mode and a second-order mode through the radiation patch, to generate an asymmetric radiation signal at an operating frequency, wherein the asymmetric radiation signal has a radiation null in a preset area, and the operating frequency is located between a frequency corresponding to the first-order mode and a frequency corresponding to the second-order mode.

2. The apparatus according to claim 1, wherein the short-circuit pillar is located near an electric wall generated by the second-order mode on the radiation patch, and a position of the short-circuit pillar does not overlap a position of an electric wall generated by the first-order mode on the radiation patch.

3. The apparatus according to claim 1, wherein a distance between the short-circuit pillar and the feeding probe is greater than ¾ times a length of the radiation patch, and the length of the radiation patch is related to a wavelength corresponding to the operating frequency.

4. The apparatus according to claim 1, wherein the radiation patch is presented as a stub-loaded slow-wave transmission structure in a length direction, and the length of the radiation patch is less than or equal to ½ times the wavelength corresponding to the operating frequency.

5. The apparatus according to claim 1, wherein the at least one polarization unit is a ±45° dual-polarization unit, a radiation patch of a +45° polarization unit and a radiation patch of a −45° polarization unit are placed in a cross manner, and an insulation medium is disposed between the radiation patch of the +45° polarization unit and the radiation patch of the −45° polarization unit.

6. The apparatus according to claim 5, wherein a distance between a short-circuit pillar of the +45° polarization unit and a tail end of the radiation patch of the +45° polarization unit is not equal to a distance between a short-circuit pillar of the −45° polarization unit and a tail end of the radiation patch of the −45° polarization unit.

7. The apparatus according to claim 1, wherein the microstrip antenna element further comprises a plurality of scattering pillars, and the plurality of scattering pillars are symmetrically distributed around the at least one polarization unit.

8. The apparatus according to claim 7, wherein the plurality of scattering pillars are located on one side of a connection line between positions of two feeding probes of the ±45° dual-polarization unit, the plurality of scattering pillars are symmetrically distributed based on a perpendicular bisector of the connection line between the positions of the two feeding probes, and two adjacent scattering pillars in the plurality of scattering pillars have a consistent center spacing.

9. The apparatus according to claim 1, wherein the antenna apparatus further comprises a plurality of electromagnetic band gap structures, and the plurality of electromagnetic band gap structures are evenly distributed around a subarray comprising at least two microstrip antenna elements.

10. The apparatus according to claim 9, wherein the electromagnetic band gap structure comprises a metal pillar and a conductor sheet, the conductor sheet is located on a surface of the dielectric substrate, and the metal pillar penetrates the dielectric substrate and is connected to a geometric center of the conductor sheet.

11. The apparatus according to claim 9, wherein the subarray comprises two microstrip antenna elements, and the subarray is a 1×2 subarray or a 2×1 subarray.

12. A system, comprising:
a transmit array and a receive array, wherein
the transmit array is configured to transmit an asymmetric radiation signal; and
the receive array is configured to receive the asymmetric radiation signal;
each of the transmit array and the receive array comprises a plurality of microstrip antenna elements, wherein each microstrip antenna element comprises at least one polarization unit, each polarization unit comprises a dielectric substrate, a radiation patch, a metal bottom plate, a feeding probe, and a short-circuit pillar, the radiation patch is located on an upper surface of the dielectric substrate, the metal bottom plate is located on a lower surface of the dielectric substrate, the feeding probe penetrates the dielectric substrate and connects one end of the radiation patch to the metal bottom plate, and the short-circuit pillar penetrates the dielectric substrate and connects the other end of the radiation patch to the metal bottom plate; and
each microstrip antenna element is configured to simultaneously excite a first-order mode and a second-order mode through the radiation patch, to generate an asymmetric radiation signal at an operating frequency, wherein the asymmetric radiation signal has a radiation null in a preset area, and the operating frequency is located between a frequency corresponding to the first-order mode and a frequency corresponding to the second-order mode.

13. The system according to claim 12, wherein the short-circuit pillar is located near an electric wall generated by the second-order mode on the radiation patch, and a position of the short-circuit pillar does not overlap a position of an electric wall generated by the first-order mode on the radiation patch.

14. The system according to claim 12, wherein a distance between the short-circuit pillar and the feeding probe is greater than ¾ times a length of the radiation patch, and the length of the radiation patch is related to a wavelength corresponding to the operating frequency.

15. The system according to claim 12, wherein the radiation patch is presented as a stub-loaded slow-wave transmission structure in a length direction, and the length of the radiation patch is less than or equal to ½ times the wavelength corresponding to the operating frequency.

16. The system according to claim 12, wherein the at least one polarization unit is a ±45° dual-polarization unit, a radiation patch of a +45° polarization unit and a radiation patch of a −45° polarization unit are placed in a cross manner, and an insulation medium is disposed between the radiation patch of the +45° polarization unit and the radiation patch of the −45° polarization unit.

17. The system according to claim 16, wherein a distance between a short-circuit pillar of the +45° polarization unit and a tail end of the radiation patch of the +45° polarization unit is not equal to a distance between a short-circuit pillar of the −45° polarization unit and a tail end of the radiation patch of the −45° polarization unit.

18. The system according to claim 12, wherein the microstrip antenna element further comprises a plurality of scattering pillars, and the plurality of scattering pillars are symmetrically distributed around the at least one polarization unit.

19. The system according to claim 18, wherein the plurality of scattering pillars are located on one side of a connection line between positions of two feeding probes of the ±45° dual-polarization unit, the plurality of scattering pillars are symmetrically distributed based on a perpendicular bisector of the connection line between the positions of the two feeding probes, and two adjacent scattering pillars in the plurality of scattering pillars have a consistent center spacing.

20. The system according to claim 12, wherein the antenna system further comprises a plurality of electromagnetic band gap structures, and the plurality of electromagnetic band gap structures are evenly distributed around a subarray comprising at least two microstrip antenna elements.
